(19) United States
(12) Patent Application Publication
(10) Pub. No.: US 2011/0258256 A1
(43) Pub. Date: Oct. 20, 2011

(54) PREDICTING FUTURE OUTCOMES

(76) Inventors: Bernardo Huberman, Palo Alto, CA (US); Sitaram Asur, Mountain View, CA (US)

(21) Appl. No.: 12/905,735

(22) Filed: Oct. 15, 2010

Related U.S. Application Data
(60) Provisional application No. 61/342,442, filed on Apr. 14, 2010.

(51) Int. Cl. G06F 15/16; G06N 7/02

(52) U.S. Cl. 709/204; 706/52

(57) ABSTRACT

A model for predicting future outcomes related to individual entities within a class of related entities may be generated based on the determined rates at which the individual entities are referenced within electronic communications. Additionally or alternatively, a quantitative value of a predicted future outcome related to a particular cause may be calculated based on the frequency with which references to the particular cause appear in electronic messages.

### CROSS REFERENCE TO RELATED APPLICATION(S)

This application claims priority from U.S. Provisional Patent Application Ser. No. 61/342,442, filed Apr. 14, 2010, and entitled “Using Social Media to Predict Future Outcomes,” which is incorporated herein by reference in its entirety.

### BACKGROUND

Many social media platforms enable users to create and share content. Examples of different social media platforms include Twitter, Facebook, Digg and MySpace and, on the academic side, JISC listservs.

### BRIEF DESCRIPTION OF THE DRAWINGS

FIG. 1 is an illustration of an example of a user interface for a social media platform.

FIG. 2 is a block diagram of a communications system.

FIG. 3 is a flowchart that illustrates an example of a process for generating a model for predicting future outcomes.

FIG. 4 is a flowchart that illustrates an example of a process for predicting a future outcome.

### DETAILED DESCRIPTION

On-line chatter within one or more social media platforms can be monitored and used to make quantitative predictions of future outcomes. Examples of the types of outcomes that can be predicted based on monitoring on-line chatter within social media platforms include future sales of a consumer product, future box office results for a motion picture, future stock prices, future election results (e.g., percentages of votes to be cast in favor of political candidates), future approval ratings of elected officials, future sales of a hardcopy or e-book, and future album sales by a performing artist (e.g., a musician or band) perhaps in a region or locale where the artist has not previously performed. Examples of different types of social media that may be monitored in order to make predictions about future outcomes include web log (blog) and microblog posts and responses (including posts and responses made within such social media platforms as Twitter, Facebook, Digg, and MySpace), instant messaging exchanges, e-mail exchanges, and other electronic communication platforms that enable and foster the exchange of thoughts between multiple different users. In order to mitigate any potential user privacy concerns, on-line chatter within any given social media platform only may be monitored for those users of the social media platform who have explicitly consented to their communications being monitored.

Initially, a model is generated for predicting outcomes related to a class of entities based upon one or more variables, at least one of which may be gleaned by monitoring on-line chatter within one or more social media platforms. Examples of different variables that may be gleaned by monitoring social media include the rate at which entities are referenced in messages exchanged within one or more social media platforms and/or sentiments expressed about the entities within one or more social media platforms. In some implementations, the model for predicting outcomes related to a class of entities may be generated by fitting a linear regression model (e.g., using least squares) to actually observed outcomes and corresponding actually observed values for one or more desired variables related to each of the observed outcomes. For example, a linear regression model may be fit to the observed success rates of individual entities within the class of entities and the corresponding rates at which the individual entities are referenced within one or more social media platforms and/or corresponding sentiments expressed about the individual entities along with any other desired variables.

After the model for predicting outcomes related to a class of entities has been constructed, a future outcome for a particular entity belonging to the class may be predicted by determining appropriate values of the variables used by the model for the particular entity, and, then, applying these values to the model. For example, when the rate at which an entity is referenced within one or more social media platforms is one of the variables used by the model to predict the future success of an entity, the one or more social media platforms may be monitored for a predefined period of time, and the number of times that the entity is referenced or the rate at which the entity is referenced in communications exchanged within the one or more social media platforms during the predefined period of time may be tracked and then applied to the model. Similarly, when sentiment is a variable used by the model to predict the future success of an entity, sentiments expressed about a particular entity in communications exchanged within one or more social media platforms may be monitored and applied to the model. The model then may be evaluated to generate a quantitative prediction of a future outcome related to the entity.

In one specific example, on-line chatter within a social media platform may be monitored and used to predict future box office success of a motion picture. In particular, a model for predicting box office success for the opening weekend of a motion picture may be generated by monitoring the frequency with which some number of different motion pictures are referenced within communications exchanged within a social media platform for a period of time (e.g., one week) leading up to their opening weekends. Then, the ticket sales for these motion pictures during their opening weekends may be observed, and a linear regression model may be fit to the frequency with which each individual motion picture was referenced within communications exchanged within the social media platform during the week leading up to the motion picture's opening weekend and the actually observed ticket sales for each motion picture during the motion picture's opening weekend.

Thereafter, the model can be used to predict the opening weekend box office success of an upcoming motion picture. In particular, in the week leading up to the opening weekend of the upcoming motion picture, the frequency with which the upcoming motion picture is referenced within communications exchanged within a social media platform may be tracked and applied to the model to predict the opening weekend box office success of the motion picture.

Various different types of social media platforms exist and still others will be created in the future. Generally speaking, social media platforms enable users to create and share content with other users. In some cases, social media platforms enable a user to share content that the user created with other users by posting the content to a website that then is accessible to other users. Common examples of such social media platforms are blog or microblog platforms that allow users to post textual content (which also may be accompanied by one or more images and/or videos) to a website that then is accessible to other users. In some cases, such social media platforms may limit the ability to access the content posted by any individual user to only a certain subset of users who the posting user has identified as being trusted by the posting user or to a subset of users who are within a predefined number of “hops” of the posting user within the posting user's social network. Such social media platforms commonly allow users who have accessed content posted by other users to post responses to the content posted by the other users. These responses then typically are connected logically to the originally posted content (e.g., in the form of message threads) so that the originally posted content and any responses thereto can be displayed or otherwise grouped together for users of the social media platform. In addition to (or as an alternative to) posting content shared by users to websites, some social media platforms may transmit content shared by users to portable electronic devices of other users.

Microblogging social media platforms are one common class of social media platforms that enable users to post and respond to content in this fashion. Typically, microblogging social media platforms enable users to post short status updates about themselves (e.g., 140 characters) that then are shared with other users of the microblogging social media platform (e.g., users who have expressed an interest in receiving status updates from the posting users and/or users who have been designated as trusted by the posting users). In addition, such microblogging social media platforms frequently allow users to respond to posts made by other users within the microblogging social media platforms. Furthermore, in some cases, microblogging social media platforms enable users accessing content posted by another user to forward or otherwise share the content posted by the other user with still additional users of the microblogging social media platform. In this fashion, users of the microblogging social media platform can communicate with one another, exchanging messages and engaging in dialogue about any number of different topics.

More generally, the term social media platform may be deemed to include any type of electronic communications platform that enables participating or subscribing users—whether or not payment of a subscription fee is required—to exchange electronic content, such as, for instance, textual messages, with one another. For example, e-mail, instant messaging, and SMS or other text-based messaging services for mobile telephones all may be considered to be social media platforms.

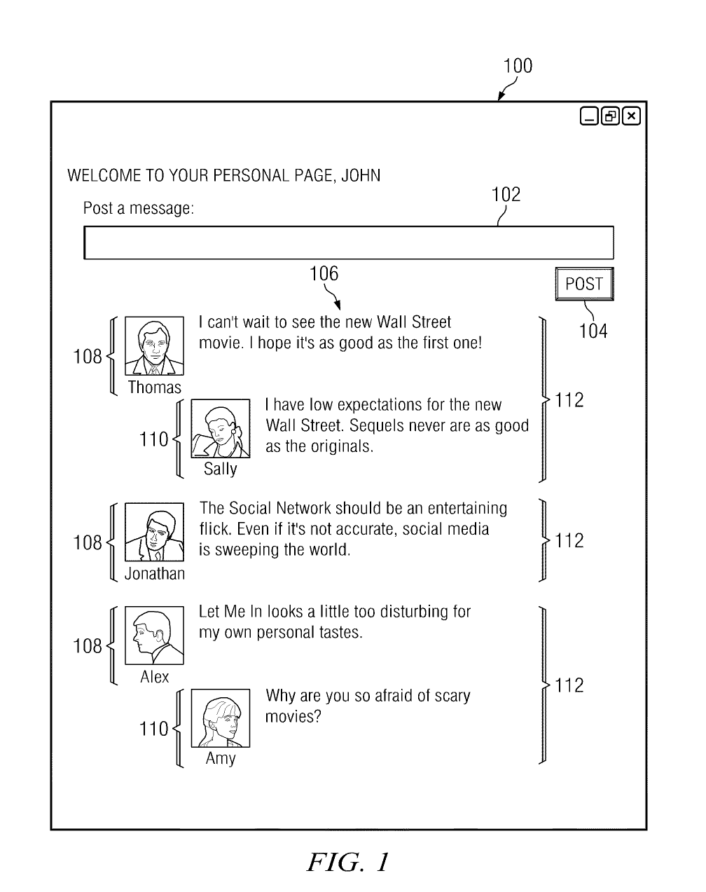

FIG. 1 is an illustration of an example of a user interface 100 for a social media platform. As illustrated in FIG. 1, the user interface 100 includes a status update field 102 and a selectable “Post” control 104. The status update field 102 is configured to receive a status update from a user of the social media platform, and the selectable “Post” control 104 is configured to enable a user of the social media platform to instruct the social media platform to share a status update entered into the status update field 102 with other users of the social media platform.

For example, after a user of the social media platform enters a status update in the status update field 102 and selects the selectable “Post” control 104, the social media platform may post the status update entered in the status update field 102 to one or more web pages that are maintained by the social media platform and that are accessible to other users of the social media platform. In some cases, when a user of the social media platform enters a status update in the status update field 102 and selects the selectable “Post” control 104, the social media platform may post the status update to web pages maintained by the social media platform that are accessible to one or more other users of the social media platform who the posting user has explicitly identified as being a friend or as otherwise being trusted by the posting user (and who, in some cases, each acknowledged the posting user as being a friend or as otherwise being trusted). Furthermore, access to the web pages to which the posting user's status update is posted may be limited only to the other users of the social media platform who the positing user has explicitly identified as being a friend or as otherwise being trusted by the posting user. Alternatively, when a user of the social media platform enters a status update in the status update field 102 and selects the selectable “Post” control 104, the social media platform may post the status update entered in the status update field 102 to one or more web pages corresponding to personal web pages maintained by the social media platform on behalf of individual users of the social media platform who have indicated a desire to be informed of any status updates posted by the user of the social media platform.

After the social media platform posts a status update for a user responsive to the user entering a status update in the status update field 102 and selecting the selectable “Post” control 104, the social media platform may provide the other users of the social media platform with whom the status update was shared with the ability to respond to the post. For example, in some implementations, the social media platform may enable a user with whom a status update was shared to respond to the status update, and the social media platform may share such a response with all other users of the social media platform with whom the original posting was shared. Furthermore, the social media platform may store such original status update postings and responses in a manner that records their relationships to each other such that they can be presented to users of the social media platform as threads that preserve the chronological order in which they were generated.

In addition to the features described above, user interface 100 also includes a message board 106 chronicling messages posted by other users of the social media platform. In particular, message board 106 includes a number of original posts 108 and several responsive posts 110, each of which is a response to an original post 108. As illustrated in FIG. 1, user interface 100 presents each original post 108 and any responsive post 110 as message threads 112 that preserve the chronological order in which the posts were shared. Furthermore, in order to reflect that responsive posts 110 are responses to original posts 108, user interface 100 presents responsive posts 110 as being indented underneath the original posts 108 to which they are responsive.

In some implementations, the social media platform may present the original posts 108 in the message board 106 of user interface 100, because the authors of these original posts 108 have been identified by the user of the user interface 100 as being friends or as otherwise being trusted (and, in some cases, because each of the authors of these original posts 108 has acknowledged the user of the user interface 100 as being a friend or as otherwise being trusted). Alternatively, in other implementations, the social media platform may present the original posts 108 in the message board 106 of user interface 100, because the user of the user interface 100 has indicated a desire to be informed of any status updates made by the authors of these original posts 108.

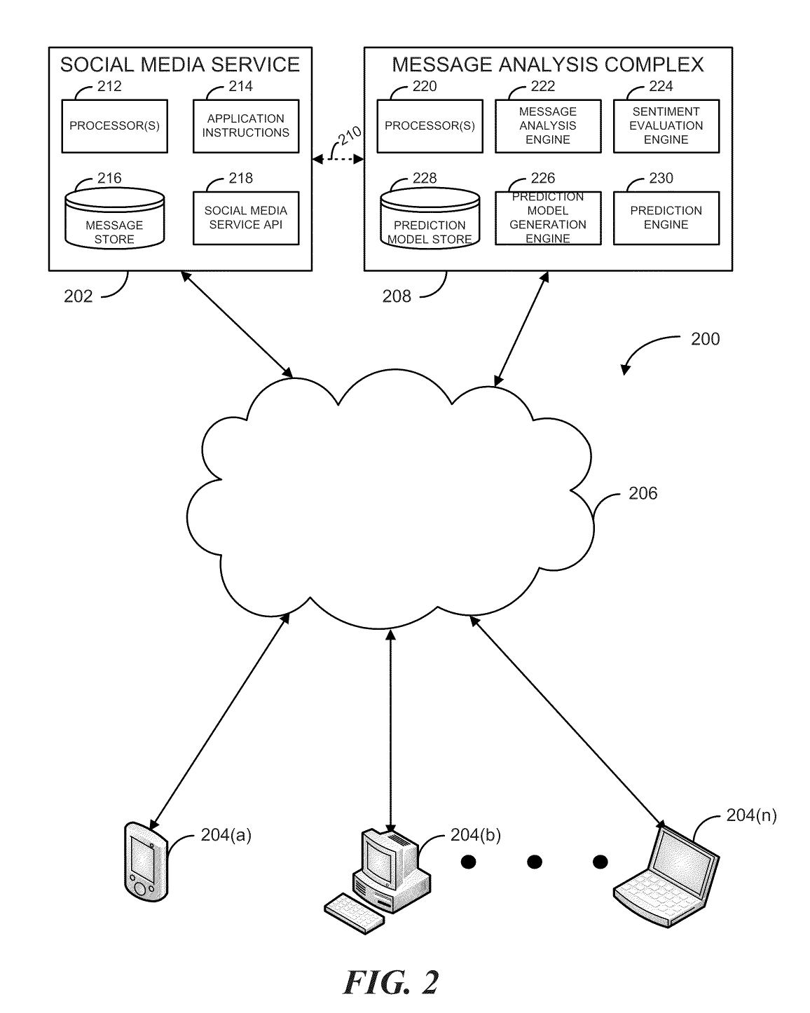

FIG. 2 is a block diagram of a communications system 200. For illustrative purposes, several elements illustrated in FIG. 2 and described below are represented as monolithic entities. However, these elements each may include and/or be implemented on numerous interconnected computing devices and other components that are designed to perform a set of specified operations and that are located proximally to one another or that are geographically displaced from one another.

As illustrated in FIG. 2, communications system 200 includes a social media service 202 that is accessible to a number of computing devices 204(a)-204(n), including, for example, a smartphone 204(a), a personal computer 204(b), and a laptop computer 204(n), over a network 206. In addition, communications system 200 also includes a message analysis complex 208 that analyzes messages exchanged using, for example, social media service 202. Message analysis complex 208 may be accessible to computing devices 204(a)-204(n) over network 206. Additionally or alternatively, social media service 202 may be accessible to message analysis complex 208 over network 206 and/or via a direction connection 210 between social media service 202 and message analysis complex 208.

Social media service 202 may be implemented using one or more computing devices (e.g., servers) configured to provide a service to one or more client devices (e.g., computing devices 204(a)-204(n)) connected to social media service 202 over network 206. The one or more computing devices on which social media service 202 is implemented may have internal or external storage components storing data and programs such as an operating system and one or more application programs. The one or more application programs may be implemented as instructions that are stored in the storage components and that, when executed, cause the one or more computing devices to provide the features of a social media service 202 as described herein. Furthermore, the one or more computing devices on which social media service 202 is implemented each may include one or more processors 212 for executing instructions stored in storage and/or received from one or more other electronic devices, for example over network 206. In addition, these computing devices also typically include network interfaces and communication devices for sending and receiving data.

As illustrated in FIG. 2, social media service 202 includes a computer memory storage system storing application instructions 214 that, when executed by processor(s) 212, enable social media service 202 to provide its social media service functionality to users. For example, by executing application instructions 214, processor(s) 212 may enable social media service 202 to provide users with the ability to create, share, and respond to messages and other content. In addition, social media service 202 includes a computer memory storage system implementing a message store 216 that stores messages exchanged by users of social media service 202 and a social media service application programming interface (API) 218 that enables other applications (e.g., message analysis complex 208) to interact with the social media service 202.

Computing devices 204(a)-204(n) may be any of a number of different types of computing devices including, for example, mobile phones; smartphones; personal digital assistants; laptop, tablet, and netbook computers; and desktop computers including personal computers, special purpose computers, general purpose computers, and/or combinations of special purpose and general purpose computers. Each of the computing devices 204(a)-204(n) typically has internal or external storage components for storing data and programs such as an operating system and one or more application programs. Examples of application programs include authoring applications (e.g., word processing programs, database programs, spreadsheet programs, or graphics programs) capable of generating documents or other electronic content; client applications (e.g., e-mail clients) capable of communicating with other computer users, accessing various computer resources, and viewing, creating, or otherwise manipulating electronic content; and browser applications capable of rendering Internet content. In addition, the internal or external storage components for each of the computing devices 204(a)-204(n) may store a client application for interfacing with social media service 202. Alternatively, in some implementations, computing devices 204(a)-204(n) may interface with social media service 202 without a specific client application, using, for example, a web browser.

Each of the computing devices 204(a)-204(n) also typically includes a central processing unit (CPU) for executing instructions stored in storage and/or received from one or more other electronic devices, for example over network 206. Each of the computing devices 204(a)-204(n) also usually includes one or more communication devices for sending and receiving data. One example of such communications devices is a modem. Other examples include antennas, transceivers, communications cards, and other network adapters capable of transmitting and receiving data over a network (e.g., network 206) through a wired or wireless data pathway.

Network 206 may provide direct or indirect communication links between hosted social media service 202, computing devices 204(a)-204(n), and message analysis complex 208 irrespective of physical separation between any of such devices. As such, individual ones of social media service 202, computing devices 204(a)-204(n), and message analysis complex 208 may be located in close geographic proximity to one another or, alternatively, individual ones of social media service 202, computing devices 204(a)-204(n), and message analysis complex 208 may be distributed across vast geographic distances. Examples of network 206 include the Internet, the World Wide Web, wide area networks (WANs), local area networks (LANs) including wireless LANs (WLANs), analog or digital wired and wireless telephone networks, radio, television, cable, satellite, and/or any other delivery mechanisms for carrying data. In some implementations, one or more of computing devices 204(a)-204(n) may be connected to network 206 over a wireless connection (e.g., a WLAN based on the IEEE 802.11 standard, a radio frequency-based wireless network, and/or a cellular or mobile telephony network provided by a wireless service provider) made available by a service provider.

Message analysis complex 208 may be implemented using one or more computing devices (e.g., servers) configured to analyze electronic messages exchanged within one or more different social media services (e.g., social media service 202) and make predictions of future outcomes based on results of analyzing the electronic messages exchanged within the one or more different social media services. The one or more computing devices on which message analysis complex 208 is implemented may have internal or external storage components storing data and programs such as an operating system and one or more application programs. The one or more application programs may be implemented as instructions that are stored in the storage components and that, when executed, cause the one or more computing devices to provide the features ascribed herein to the message analysis complex 208. Furthermore, the one or more computing devices on which message analysis complex 208 is implemented each may include one or more processors 220 for executing instructions stored in storage and/or received from one or more other electronic devices, for example, over network 206. In addition, these computing devices also typically include network interfaces and communication devices for sending and receiving data. In some cases, message analysis complex 208 may be implemented as a component of social media service 202.

As illustrated in FIG. 2, message analysis complex 208 includes a message analysis engine 222. As will be described in greater detail below, message analysis engine 222 is configured to analyze electronic messages exchanged by users of one or more social media services (e.g., social media service 202) and to determine if messages exchanged by users of the one or more social media services reference particular concerns. For example, in some implementations, message analysis engine 222 may be configured to analyze electronic messages exchanged by users of one or more social media services (e.g., social media service 202) and to determine how frequently messages exchanged by users of the one or more social media services reference particular motion pictures. In such implementations, message analysis engine 222 may be capable of determining that a message exchanged using one of the one or more social media services references a particular motion picture even if the message does not use the full or proper title for the motion picture. For instance, message analysis engine 222 may be configured to recognize shorthand references to, similes for, and/or misspellings of titles for different motion pictures. In some cases, message analysis engine 222 may be implemented as a set of instructions stored in a computer memory storage system that, when executed by processor(s) 220, cause processor(s) 220 to provide the functionality ascribed herein to message analysis engine 222.

Message analysis complex 208 also includes a sentiment evaluation engine 224. As will be described in greater below, sentiment evaluation engine is configured to analyze messages exchanged by users of one or more social media services (e.g., social media service 202) that have been determined (e.g., by message analysis engine 222) to reference particular concerns and to classify sentiments expressed about the particular concerns within the messages. For example, message analysis complex 208 may be configured to identify sentiments expressed about a particular concern within messages exchanged using one or more of the social media services as being either negative, neutral, or positive. In some cases, sentiment evaluation engine 224 may be implemented as a set of instructions stored in a computer memory storage system that, when executed by processor(s) 220, cause processor(s) 220 to provide the functionality ascribed herein to sentiment evaluation engine 224.

Message analysis complex 208 also includes a prediction model generation engine 226. As will be described in greater detail below, prediction model generation engine 226 is configured to build prediction models for predicting future outcomes related to different types of concerns based upon messages exchanged using one or more different social media services (e.g., social media service 202). For example, in some implementations, prediction model generation engine 226 may be configured to build a prediction model for predicting future box office results for motion pictures based upon the frequency with which electronic messages exchanged using the one or more social media services reference the motion pictures. Additionally or alternatively, prediction model generation engine 226 may be configured to build a prediction model for predicting future box office results for motion pictures based upon sentiments expressed within electronic messages exchanged using the one or more social media services. In some cases, prediction model generation engine 226 may be implemented as a set of instructions stored in a computer memory storage system that, when executed by processor(s) 220, cause processor(s) 220 to provide the functionality ascribed herein to prediction model generation engine 226.

Message analysis complex 208 also includes a computer memory storage system implementing a prediction model store 228. Prediction model store 228 stores models for predicting future outcomes related to different types of concerns based upon messages exchanged using one or more different social media services (e.g., social media service 202). One or more of the prediction models stored in prediction model store 228 may have been built by prediction model generation engine 226.

Message analysis complex 208 also includes a prediction engine 230. As will be described in greater detail below, prediction engine 230 is configured to apply prediction models (e.g., stored in prediction model store 228) to information gleaned (e.g., by one or both of message analysis engine 222 and sentiment evaluation engine 224) from messages exchanged using one or more different social media services 202. For example, in some implementations, prediction engine 226 may be configured to predict future box office results for a particular motion picture by applying the frequency with which the particular motion picture is referenced within messages exchanged using the one or more social media services (e.g., as determined by message analysis engine 222) and/or sentiments expressed about the particular motion picture within messages exchanged using the one or more social media services (e.g., as determined by sentiment evaluation engine 224) to a model (e.g., stored in prediction model store 228) for predicting box office results for a motion picture based on the frequency with which the motion picture is referenced in messages exchanged using the one or more social media services and/or sentiments expressed about the particular motion picture within messages exchanged using the one or more social media services. In some cases, prediction engine 230 may be implemented as a set of instructions stored in a computer memory storage system that, when executed by processor(s) 220, cause processor(s) 220 to provide the functionality ascribed herein to prediction engine 230.

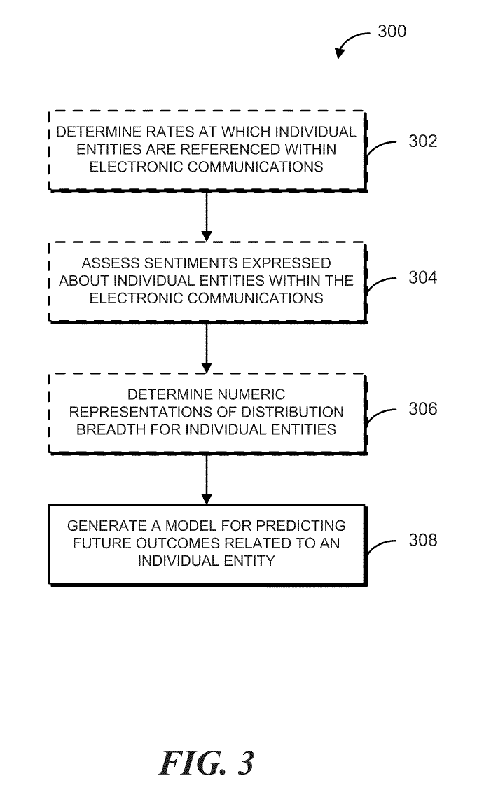

FIG. 3 is a flowchart 300 that illustrates an example of a process for generating a model for predicting future outcomes related to an entity using information gleaned from electronic communications exchanged using one or more social media platforms. The process illustrated in the flow chart 300 of FIG. 3 may be performed by a message analysis complex, such as, for example, message analysis complex 208 of FIG. 2, and, in particular, one or more of message analysis engine 222, sentiment evaluation engine 224, and prediction model generation engine 226 of message analysis complex 208 of FIG. 2. Furthermore, the process illustrated in the flow chart 300 of FIG. 3 may be performed using a historical or training set of electronic communications exchanged using one or more social media platforms in order to generate a model that then can be used to predict future outcomes.

Referring to FIG. 3, rates at which individual entities within a class of related entities are referenced within electronic communications exchanged using one or more social media platforms may be determined (302). For example, as part of generating a model for predicting box office results for different motion pictures, message analysis engine 222 of message analysis complex 208 of FIG. 2 may determine rates at which different motion pictures are referenced within electronic communications exchanged using one or more social media platforms during a predefined time period (e.g., the week prior to release or the week after release).

Then, for those electronic communications exchanged using the one or more social media platforms that were identified as including references to individual ones of the class of related entities, sentiments expressed about the individual entities within the electronic communications may be assessed (304). For example, continuing with the example of building a model for predicting future box office results for motion pictures, sentiment evaluation engine 224 of message analysis complex 208 of FIG. 2 may assess, for those electronic communications identified as including references to different motion pictures, sentiments expressed about the motion pictures within the electronic communications.

Numerous different techniques may be used to classify sentiments expressed in textual messages, some of which involve labeling a textual message as expressing either a positive, negative or neutral sentiment. In one implementation, a sentiment analysis classifier utilizes the LingPipe linguistic analysis package (available at http://www.alias-i.com/lingpipe), which provides a set of open-source Java libraries for natural language processing tasks, and the DynamicLMClassifier, which is a language model classifier that accepts training events of categorized character sequences.

This implementation may be trained based on a multivariate estimator for the category distribution and dynamic language models for the per-category character sequence estimators. To obtain labeled training data for the classifier, sentiments (e.g., positive, negative, or neutral) may be manually assigned for a random sample of messages. For example, each message may be labeled by at least three different human voters and only samples for which all three voters assigned the same label may be used to train the classifier. Furthermore, before the sample messages are used to train the classifier, stop words (e.g., articles, prepositions, etc.), special characters (perhaps excluding exclamation marks, which may be replaced by <EX>, and question marks, which may be replaced by <QM>), uniform resource locators (URLs), and/or usernames may be removed from the sample messages.

The sample messages then may be used to train the classifier to assign a positive, negative, or neutral label to a message using an n-gram model, for example, with n chosen to be 8. After training the classifier, the classifier may be used to determine a sentiment for a message and to assign an appropriate label to the message based on the determined sentiment for the message.

To quantify the overall sentiment expressed in electronic messages for an entity, the ratio of messages identified as expressing positive sentiments for the entity to messages identified as expressing negative sentiments for the entity may be determined. In some cases, this ratio may be defined as the polarity ratio for the entity:

$$PN ratio = \frac{\vert Messages Expressing Positive Sentiments \vert}{\vert Messages Expressing Negative Sentiments \vert} \qquad ( Eq . 1 )$$

Referring again to FIG. 3, numeric representations of the breadth with which individual ones of the class of related entities are distributed also may be determined (306). For instance, continuing still with the example of building a model for predicting future box office results for motion pictures, the number of different theaters at (or screens on) which each motion picture is playing may be determined.

Then, based on results of one or more of the preceding operations, a model for predicting future outcomes related to an individual entity is generated (308). For example, in the case of the model for predicting future box office results for motion pictures, prediction model generation engine 226 of message analysis complex 208 of FIG. 3 may observe or otherwise access actual box office results for the motion pictures and, thereafter, generate a model for predicting box office results for motion pictures based on the actually observed box office results for the motion pictures and one or more of (1) the rates at which the motion pictures were referenced in electronic communications exchanged using the one or more social media services, (2) sentiments expressed about the motion pictures in electronic communications exchanged using the one or more social media services, and (3) the breadths with which the motion pictures were distributed.

In one specific example, a linear regression model for predicting a numeric representation of a future outcome related to a particular entity is fit (e.g., using the least squares method) to observed actual outcomes for entities within the related class of entities and (1) the rates at which the entities were referenced in electronic communications exchanged using the one or more social media services, (2) the sentiments expressed about the entities in electronic communications exchanged using the one or more social media services, and (3) the breadths with which the entities were distributed. This model may be expressed as:

y=βₐ*A+βₚ*P+β_{d}*D+ε (Eq. 2)

where y is the numeric representation of the predicted future outcome for the entity, A is the rate at which the entity is referenced within communications exchanged using one or more social media platforms during a predefined period of time, P is a numeric representation of sentiments expressed about the entity within communications exchanged using the one or more social media platforms, D is a numeric representation of the distribution breadth for the entity, ε represents an error term, and the β values are the determined regression coefficients corresponding to A, P, and D. In the case of the example of the model for predicting box office results for a motion picture, A may be the rate at which the motion picture is referenced in electronic communications exchanged using the one or more social media platforms during a predefined period of time, P may be the polarity ratio of the sentiments expressed about the motion picture in electronic communications exchanged using the one or more social media platforms, and D may be the number of theaters at (or screens on) which the motion picture is playing.

In order to use Equation 2 to calculate a numeric representation of a future outcome related to a particular entity (e.g., box office results for a motion picture), one or more social media platforms may be monitored to determine both the rate at which the entity (e.g., the motion picture) is referenced in electronic communications exchanged using the one or more social media platforms during a predefined period of time as well as the sentiments that are expressed about the entity (e.g., the motion picture) within the electronic communications exchanged using the one or more social media platforms during the predefined period of time. Based on these findings, values for A and P then may be determined. In addition, a value for D may be determined based on the breadth of distribution of the entity (e.g., the number of theaters at (or screens on) which the motion picture is playing). Then, the determined values for A, P, and D may be applied to the model to yield a value for y, the numeric representation of the predicted future outcome for the particular entity (e.g., box office results for the motion picture).

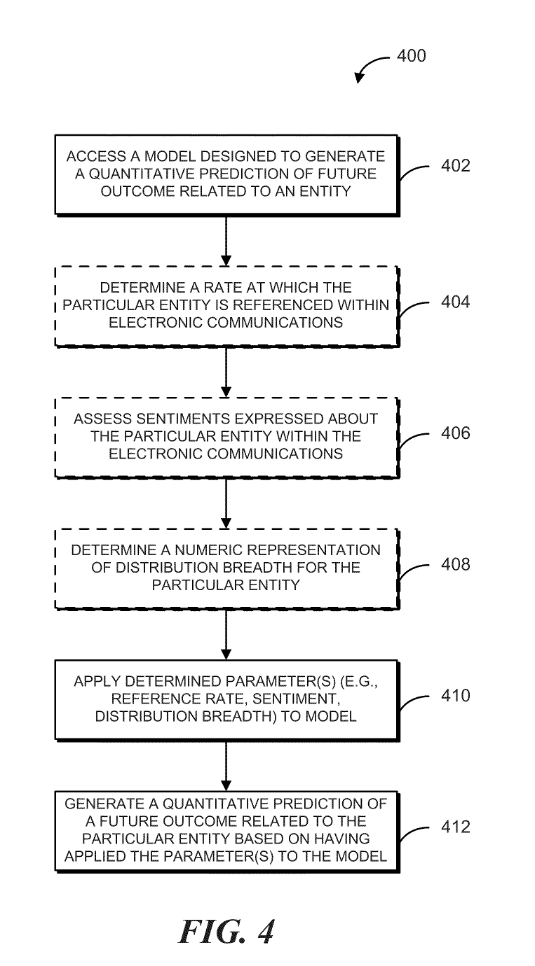

FIG. 4 is a flowchart 400 that illustrates an example of a process for predicting a future outcome related to a particular entity using information gleaned from electronic communications exchanged using one or more social media platforms. The process illustrated in the flow chart 400 of FIG. 4 may be performed by a message analysis complex, such as, for example, message analysis complex 208 of FIG. 2, and, in particular, one or more of message analysis engine 222, sentiment evaluation engine 224, and prediction engine 230 of message analysis complex 208 of FIG. 2.

Referring to FIG. 4, a model designed to generate a quantitative prediction of a future outcome related to a particular entity based on information gleaned from electronic communications exchanged using one or more social media platforms is accessed (402). For example, as part of predicting future box office results for a particular motion picture, prediction engine 230 of message analysis complex 208 of FIG. 2 may access a model designed to generate a quantitative prediction of future box office results for motion pictures based on information gleaned from electronic communications exchanged using one or more social media platforms from prediction model store 228 of message analysis complex 208 of FIG. 2.

In addition, a rate at which the particular entity is referenced within electronic communications exchanged using the one or more social media platforms during a predefined period of time may be determined (404). For instance, continuing with the example of predicting future box office results for a particular motion picture, message analysis engine 222 of message analysis complex 208 of FIG. 2 may analyze electronic communications exchanged using the one or more social media platforms during a predefined period of time and determine a rate at which the particular motion picture was referenced within the electronic communications exchanged during the predefined period of time using the one or more social media platforms.

Sentiments expressed about the particular entity within the electronic communications that were exchanged using the one or more social media platforms during the predefined period of time and that were identified as referencing the particular entity also may be assessed (406). Continuing still with the example of predicting future box office results for a particular motion picture, sentiment evaluation engine 224 of message analysis complex 208 of FIG. 2 may assess and quantify (e.g., by calculating the polarity ratio) the sentiments expressed about the particular motion picture within the electronic communications that were exchanged using the one or more social media platforms during the predefined period of time and that were identified as referencing the particular motion picture.

Additionally or alternatively, a numeric representation of the distribution breadth for the particular entity also may be determined (408). Returning again to the example of predicting future box office results for a particular motion picture, message analysis complex 208 of FIG. 2 may determine how many theaters at (or screens) on which the particular motion picture is playing.

Then, one or more of the determined parameters (e.g., the rate at which the particular entity was referenced in electronic communications exchanged using the one or more social media platforms, the sentiments expressed about the particular entity within the electronic communications exchanged using the one or more social media platforms, and/or the distribution breadth of the particular entity) are applied to the model (410), and a quantitative prediction of a future outcome related to the particular entity is generated based on having applied the determined parameters to the model (412). Proceeding with the example of predicting future box office results for a particular motion picture, prediction engine 230 of message analysis complex 208 may apply one or more of (1) the frequency with which the particular motion picture was referenced within electronic communications exchanged using the one or more social media platforms, (2) the sentiments expressed about the particular motion picture within messages exchanged using the one or more social media platforms, and (3) the distribution breadth of the particular motion picture in order to generate a prediction of the revenue to be generated by the particular motion picture.

As one specific illustration of making quantitative predictions of future outcomes based on the on-line chatter of a social-media community, techniques for predicting the box office results of motion pictures based on monitoring social media are presented. Specifically, techniques are presented for predicting box office results of motion pictures based on monitoring user-supplied messages posted to the Twitter (e.g., http://www.twitter.com) social media platform, often referred to colloquially as “tweets.”

Twitter is an online microblogging service that may be considered to be a directed social network, where each user has a set of subscribers known as followers who have indicated an interest in receiving “tweets” posted by the user. Each user submits “tweets,” that generally are short messages having, for example, a maximum size of 140 characters. Examples of the type of information typically included within these posts include personal information about the users who posted them, news, or links to content such as images, video and articles. Posts made by a user are displayed on the user's profile page as well as delivered to his/her followers. Twitter also allows a user to send a direct message to another user. Such messages typically are preceded by “@userid” to indicate their intended destinations. A “retweet” is a post originally made by one user that is forwarded by another user. These “retweets” are a popular means of propagating interesting posts and links through the Twitter social media platform.

In implementations that predict box office results of motion pictures based on monitoring “tweets” posted to Twitter, daily feed data may be crawled, for example, using the online Twitter Search API (http://search.twitter.com/api/). Keywords present in a particular motion picture title then may be used to extract all “tweets” that refer to the motion picture from the daily feed data. In some cases, only the author, timestamp and “tweet” text fields of the daily feed data may be extracted and analyzed. This information then may be used to predict box office results for the motion picture and/or to build a predictive model for predicting box office results for motion pictures.

A linear regression model for predicting box office results for a motion picture using the average “tweet”-rate (i.e., the number of “tweets” referring to a particular motion picture per hour) for the motion picture, over the week prior to the motion picture's release, may be generated based on information extracted from the daily feed data for a sample set of motion pictures. In one specific example in which 24 motion pictures were considered in the sample set of motion pictures, the linear regression model for predicting box office results using the average “tweet”-rate as a predictor revealed a correlation between the “tweet”-rates for the motion pictures and the revenue generated by the motion pictures during their first weekend of release, which, for this example, was extracted from the Box Office Mojo website (i.e., http://boxofficemoio.com/). In particular, the linear regression model exhibited a correlation coefficient of 0.90; an adjusted R² value of 0.80; and a p-value of 3.65×10⁻⁰⁹***, where the “***” shows significance at 0.001. Alternatively, a linear regression model for predicting box office results for a motion picture may be generated using the timeseries values of the “tweet”-rates for a sample set of motion pictures for the 7 days before the motion pictures are released (e.g., seven variables, each corresponding to the “tweet”-rate for a motion picture for a particular day) and/or the number of theaters at which the motion pictures were released also may be performed. Data demonstrating the correlation between the variables discussed above and box office results is presented in Table 1 below:

TABLE 1

| | Adjusted R² | |
|---|---|---|
| Predictor(s) | Value | P-value |
| Avg. “Tweet”-rate | 0.8 | 3.65 × 10⁻⁰⁹ |
| “Tweet”-rate Timeseries | 0.93 | 5.279 × 10⁻⁰⁹ |
| “Tweet”-rate Timeseries + Theater Count | 0.973 | 9.14 × 10⁻¹⁰ |

In some implementations, a regression model combining both the “tweet”-rate values and prices from the Hollywood Stock Exchange (HSX) (see http://www.hsx.com/) may be constructed to predict the box office results of a particular motion picture. Referring again to the same example data set for 24 motion pictures discussed above, constructing a regression model that combined both the “tweet”-rate values and the HSX prices to predict box office results resulted in an adjusted R² value of almost 0.99.

After a linear regression model for predicting box office performance has been generated, the box office performance of an individual motion picture may be predicted by determining the values of the predictors used by the model (e.g., “tweet”-rate, “tweet”-rate timeseries, and/or theater count) for the motion picture and then applying the determined values for the predictors to the model.

In addition to predicting box office results for a motion picture on its opening weekend, implementations also may predict revenue for a motion picture for any given weekend based on information gleaned from social media. For example, the “tweet”-rate timeseries for motion pictures over the 7 day period before any weekend may be used to generate linear regression models for predicting the box office revenue for motion pictures for that particular weekend. (Results of using different predictors to generate linear regression models for predicting box office revenues for the second weekend of release for a sample data set of motion pictures are presented in Table 2 below.) Furthermore, “tweet”-rate timeseries for the individual motion pictures for different weekends, the theater counts for individual motion pictures, and the number of weeks for which individual motion pictures have been released all may be used as predictors for models for predicting the box office results for motion pictures on any given weekend.

In predicting box office results for motion pictures, some implementations also may monitor sentiments expressed in social media about motion pictures in addition to (or as an alternative to) the rate at which motion pictures are mentioned in social media. As discussed above, numerous different techniques may be used to classify sentiments expressed in electronic messages exchanged using social media platforms. In addition, after sentiments expressed in “tweets” have been classified for a motion picture, the sentiments for the motion picture can be quantified by calculating the polarity ratio, namely the ratio of positive to negative tweets for the motion picture.

The polarity ratio captures some variance in box office revenues for different motion pictures. Therefore, a linear regression model for predicting box office revenues may be constructed using the polarity ratio as a variable. For example, results of generating linear regression models for predicting box office revenues for the second weekend of release using polarity ratio as a predictor for a sample data set of motion pictures are presented in Table 2 below:

TABLE 2

| | Adjusted R² | |
|---|---|---|
| Predictor(s) | Value | P-value |
| Avg. “Tweet”-rate | 0.79 | 8.39 × 10⁻⁰⁹ |
| Avg. “Tweet”-rate + Theater Count | 0.83 | 7.93 × 10⁻⁰⁹ |
| Avg. “Tweet”-rate + PNratio | 0.92 | 4.31 × 10⁻¹² |
| “Tweet”-rate timeseries | 0.84 | 4.18 × 10⁻⁰⁶ |
| “Tweet”-rate Timeseries + Theater Count | 0.863 | 3.64 × 10⁻⁰⁶ |
| “Tweet”-rate Timeseries + PNratio | 0.94 | 1.84 × 10⁻⁰⁸ |

As illustrated in Table 2, using “tweet”-rate as a predictor provides nearly the same predictive power in the second week of a motion picture's release as it does for the first weekend of release, while adding sentiment as an additional variable to the regression model improved the predictive power of the model when used with both the average “tweet”-rate and the “tweet”-rate timeseries.

Table 3 below shows the regression p-values when average “tweet”-rate and sentiment are used as predictors, demonstrating that the coefficients are significant in both cases.

TABLE 3

| Predictor | P-value |
|---|---|
| Avg. “Tweet”-rate | 2.05 × 10⁻¹¹ (***) |
| PNRatio | 9.43 × 10⁻⁰⁶ (***) |

After linear regression models for predicting box office performance have been generated using, among other predictors, sentiment, the box office performance of an individual motion picture may be predicted by determining the values for the motion picture of the predictors used by the models, including sentiment, and then applying the determined values for the predictors to the model.

A number of methods, techniques, systems, and apparatuses for predicting future outcomes have been described. These methods, techniques, systems, and apparatuses can be used to predict a number of different types of future outcomes including, for example, future sales of a consumer product, future box office results for a motion picture, future stock prices, future election results (e.g., percentages of votes to be cast in favor of political candidates), future approval ratings of elected officials, future sales of a hardcopy or e-book, and future album sales by a performing artist (e.g., a musician or band) perhaps in a region or locale where the artist has not previously performed.

Moreover, the described systems, methods and techniques may be implemented in digital electronic circuitry, computer hardware, software, firmware, or in combinations of these elements. Apparatuses implementing these techniques may include appropriate input and output devices, a computer processor, and/or a tangible computer-readable storage medium storing instructions for execution by a processor. A process implementing techniques disclosed herein may be performed by a processor executing instructions stored on a tangible computer readable storage medium for performing desired functions by operating on input data and generating appropriate output. Suitable processors include, by way of example, both general and special purpose microprocessors. Suitable computer-readable storage devices for storing executable instructions include all forms of non-volatile memory, including, by way of example, semiconductor memory devices, such as Erasable Programmable Read-Only Memory (EPROM), Electrically Erasable Programmable Read-Only Memory (EEPROM), and flash memory devices, magneto-optical disks, and Compact Disc Read-Only Memory (CD-ROM). Any of the foregoing may be supplemented by, or incorporated in, specially designed application-specific integrated circuits (ASICs).

Although the operations of the disclosed techniques may be described herein as being performed in a certain order, in some implementations, individual operations may be rearranged in a different order and/or eliminated and the desired results still may be achieved. Similarly, components in the disclosed systems may be combined in a different manner and/or replaced or supplemented by other components and the desired results still may be achieved.

What is claimed is:

1. A computer-implemented method for generating a quantitative prediction of a future outcome related to a particular entity, the method comprising:
accessing, from a computer memory storage system, a linear regression model designed to generate a quantitative prediction of a future outcome related to an entity based upon a rate at which the entity is referenced within electronic communications transmitted within one or more social media platforms hosted by one or more corresponding computer systems;
determining, using at least one processing element, a rate at which the particular entity is referenced within electronic communications transmitted within the one or more social media platforms;
applying, using at least one processing element, the determined rate to the accessed linear regression model; and
generating, using at least one processing element, a quantitative prediction of a future outcome related to the particular entity based on having applied the determined rate to the accessed linear regression model.

2. The method of claim 1 wherein:
accessing a linear regression model designed to generate a quantitative prediction of a future outcome related to an entity based upon a rate at which the entity is referenced within electronic communications transmitted within one or more social media platforms includes accessing a linear regression model designed to generate a quantitative prediction of a future outcome related to an entity based upon a rate at which the entity is referenced within electronic communications transmitted within an individual social media platform; and
determining a rate at which the particular entity is referenced within electronic communications transmitted within the one or more social media platforms includes determining a rate at which the particular entity is referenced within electronic communications transmitted within the individual social media platform.

3. The method of claim 2 wherein:
the social media platform supports microblogging and enables users to post microblog posts to the social media platform;
accessing a linear regression model designed to generate a quantitative prediction of a future outcome related to an entity based upon a rate at which the entity is referenced within electronic communications transmitted within an individual social media platform includes accessing a linear regression model designed to generate a quantitative prediction of a future outcome related to an entity based upon a rate at which the entity is referenced within microblog posts posted to the social media platform; and
determining a rate at which the particular entity is referenced within electronic communications transmitted within the individual social media platform includes determining a rate at which the particular entity is referenced within microblog posts posted to the social media platform.

4. The method of claim 1 further comprising generating a quantitative representation of sentiments expressed about the particular entity within the electronic communications transmitted within the one or more social media platforms, wherein:
accessing a linear regression model designed to generate a quantitative prediction of a future outcome related to an entity based upon the rate at which the entity is referenced within electronic communications transmitted within the one or more social media platforms includes accessing a linear regression model designed to generate a quantitative prediction of a future outcome related to an entity based upon sentiments expressed about the entity within electronic communications transmitted within the one or more social media platforms in addition to the rate at which the entity is referenced within electronic communications transmitted within the one or more social media platforms;
applying the determined rate to the accessed linear regression model includes applying the quantitative representation of the sentiments expressed about the particular entity to the accessed linear regression model in addition to the determined rate; and
generating the quantitative prediction of a future outcome related to the particular entity based on having applied the determined rate to the accessed linear regression model includes generating the quantitative prediction of a future outcome related to the particular entity based on having applied the determined rate and the quantitative representation of the sentiments expressed about the particular entity to the accessed linear regression model.

5. The method of claim 4 wherein:
generating a quantitative representation of sentiments expressed about the particular entity within the electronic communications transmitted within the one or more social media platforms includes:
identifying electronic communications transmitted within the one or more social media platforms that reference the particular entity,
among those electronic communications transmitted within the one or more social media platforms identified as referencing the particular entity, determining that a first number express positive sentiments about the particular entity and that a second number express negative sentiments about the particular entity, and
calculating a ratio of the first number of electronic communications determined to express positive sentiments about the particular entity to the second number of electronic communications determined to express negative sentiments about the particular entity;
applying the quantitative representation of the sentiments expressed about the particular entity to the accessed linear regression model in addition to the determined rate includes applying the ratio of the first number of electronic communications determined to express positive sentiments about the particular entity to the second number of electronic communications determined to express negative sentiments about the particular entity to the linear regression model in addition to the determined rate; and
generating the quantitative prediction of a future outcome related to the particular entity based on having applied the determined rate and the quantitative representation of the sentiments expressed about the particular entity to the accessed linear regression model includes generating a quantitative prediction of a future outcome related to the particular entity based on having applied the determined rate and the ratio of the first number of electronic communications determined to express positive sentiments about the particular entity to the second number of electronic communications determined to express negative sentiments about the particular entity to the accessed linear regression model.

6. The method of claim 1 wherein:
accessing a linear regression model designed to generate a quantitative prediction of a future outcome related to an entity based upon a rate at which the entity is referenced within electronic communications transmitted within one or more social media platforms includes accessing a linear regression model designed to generate a prediction of revenue to be generated by a motion picture during a period of time based upon a rate at which the motion picture is referenced within electronic communications transmitted within one or more social media platforms;
determining a rate at which a particular entity is referenced within electronic communications transmitted within the one or more social media platforms includes determining a rate at which a particular motion picture is referenced within electronic communications transmitted within the individual social media platform;
applying the determined rate to the accessed linear regression model includes applying the determined rate at which the particular motion picture is referenced within electronic communications transmitted within the one or more social media platforms to the accessed linear regression model; and
generating a quantitative prediction of a future outcome related to the particular entity based on having applied the determined rate to the accessed linear regression model includes generating a prediction of revenue to be generated by the particular motion picture during a period of time based on having applied the determined rate at which the particular motion picture is referenced within electronic communications transmitted within the one or more social media platforms to the accessed linear regression model.

7. A computer-implemented method comprising:
monitoring, using at least one processing element, electronic communications transmitted within one or more social media platforms hosted by one or more corresponding computer systems;
based on monitoring the electronic communications transmitted within the one or more social media platforms, determining, using at least one processing element, rates at which each of a number of individual entities within a class of related entities are referenced within electronic communications transmitted within the one or more social media platforms; and
generating, using at least one processing element, a model for predicting future outcomes related to individual entities within the class of related entities based on the determined rates at which the individual entities are referenced within electronic communications transmitted within the one or more social media platforms.

8. The method of claim 7 wherein:
monitoring electronic communications transmitted within one or more social media platforms includes monitoring electronic communications transmitted within an individual social media platform;
determining rates at which each of a number of individual entities within a class of related entities are referenced within electronic communications transmitted within the one or more social media platforms includes determining rates at which each of a number of individual entities within a class of related entities are referenced within electronic communications transmitted within the individual social media platform; and
generating a model for predicting future outcomes related to individual entities within the class of related entities based on the determined rates at which the individual entities are referenced within electronic communications transmitted within the one or more social media platforms includes generating a model for predicting future outcomes related to individual entities within the class of related entities based on the determined rates at which the individual entities are referenced within electronic communications transmitted within the individual social media platform.

9. The method of claim 8 wherein:
the social media platform supports microblogging and enables users to post microblog posts to the social media platform;
monitoring electronic communications transmitted within the social media platform includes monitoring microblog posts posted to the social media platform;
determining rates at which each of a number of individual entities within a class of related entities are referenced within electronic communications transmitted within the social media platform includes determining rates at which each of a number of individual entities within a class of related entities are referenced within microblog posts posted within the social media platform; and
generating a model for predicting future outcomes related to individual entities within the class of related entities based on the determined rates at which the individual entities are referenced within electronic communications transmitted within the social media platform includes generating a model for predicting future outcomes related to individual entities within the class of related entities based on the determined rates at which the individual entities are referenced within microblog posts posted within the social media platform.

10. The method of claim 7 further comprising generating quantitative representations of sentiments expressed about the individual entities within the class of related entities within the electronic communications transmitted within the one or more social media platforms based on monitoring the electronic communications transmitted within the one or more social media platforms, wherein:
generating a model for predicting future outcomes related to individual entities within the class of related entities based on the determined rates at which the individual entities are referenced within electronic communications transmitted within the one or more social media platforms includes generating a model for predicting future outcomes related to individual entities within the class of related entities based on the quantitative representations of sentiments expressed about the individual entities within the class of related entities within the electronic communications transmitted within the one or more social media platforms in addition to the determined rates at which the individual entities are referenced.

11. The method of claim 10 wherein:
generating quantitative representations of sentiments expressed about the individual entities within the class of related entities within the electronic communications transmitted within the one or more social media platforms includes:
identifying, for each of the individual entities, electronic communications transmitted within the one or more social media platforms that reference the entity,
determining, for each of the individual entities, that, among those electronic communications transmitted within the one or more social media platforms identified as referencing the entity, a first number express positive sentiments about the entity and that a second number express negative sentiments about the entity, and
calculating, for each of the individual entities, a ratio of the first number of electronic communications determined to express positive sentiments about the entity to the second number of electronic communications determined to express negative sentiments about the entity; and
generating a model for predicting future outcomes related to individual entities within the class of related entities based on the quantitative representations of sentiments expressed about the individual entities within the class of related entities within the electronic communications transmitted within the one or more social media platforms in addition to the determined rates at which the individual entities are referenced includes generating a model for predicting future outcomes related to individual entities within the class of related entities based on the ratios calculated for each individual entity of the first number of electronic communications determined to express positive sentiments about the entity to the second number of electronic communications determined to express negative sentiments about the entity in addition to the determined rates at which the individual entities are referenced.

12. The method of claim 7 wherein:
determining rates at which each of a number of individual entities within a class of related entities are referenced within electronic communications transmitted within the one or more social media platforms includes determining rates at which each of a number of different motion pictures are referenced within electronic communications transmitted within the one or more social medial platforms; and
generating a model for predicting future outcomes related to individual entities within the class of related entities based on the determined rates at which the individual entities are referenced within electronic communications transmitted within the one or more social media platforms includes generating a model for predicting revenue to be generated by a motion picture during a future period of time based on the determined rates at which the different motion pictures are referenced within electronic communications transmitted within the one or more social media platforms.

13. A computer-readable storage medium storing instructions that, when executed by one or more processing elements, cause the one or more processing elements to:
monitor a frequency with which references to a particular cause appear in messages transmitted through an electronic, textual messaging service; and
calculate a quantitative value of a predicted future outcome related to the particular cause based on the frequency with which the references to the particular cause appear in the messages transmitted through the electronic, textual messaging service.

14. The computer-readable storage medium of claim 13 further comprising instructions that, when executed by one or more processing elements, cause the one or more processing elements to monitor sentiments expressed about the particular cause in the messages transmitted through the electronic, textual message service, wherein:
the instructions that, when executed by one or more processing elements, cause the one or more processing elements to calculate a quantitative value of a predicted future outcome related to the particular cause based on the frequency with which the references to the particular cause appear in the messages transmitted through the electronic, textual messaging service include instructions that, when executed by one or more processing elements, cause the one or more processing elements to calculate a quantitative value of a predicted future outcome related to the particular cause based on the sentiments expressed about the particular cause in the messages transmitted through the electronic, textual message service in addition to the frequency with which the references to the particular cause appear in the messages transmitted through the electronic, textual messaging service.

15. The computer-readable storage medium of claim 13 wherein:
the instructions that, when executed by one or more processing elements, cause the one or more processing elements to monitor a frequency with which references to a particular cause appear in messages transmitted through an electronic, textual messaging service include instructions that, when executed by one or more processing elements, cause the one or more processing elements to monitor a frequency with which references to a particular motion picture appear in messages transmitted through an electronic, textual messaging service; and
the instructions that, when executed by one or more processing elements, cause the one or more processing elements to calculate a quantitative value of a predicted future outcome related to the particular cause based on the frequency with which the references to the particular cause appear in the messages transmitted through the electronic, textual messaging service include instructions that, when executed by the one or more processing elements, cause the one or more processing elements to calculate a predicted future revenue to be generated by the particular motion picture during a period of time based on the frequency with which the references to the particular motion picture appear in the messages transmitted through the electronic, textual message service.
